(19) United States
(12) Patent Application Publication
(10) Pub. No.: US 2026/0015167 A1
(43) Pub. Date: Jan. 15, 2026

(54) METHOD FOR ORDER PREPARATION AND PACKING

(71) Applicant: EXOTEC PRODUCT FRANCE, CROIX (FR)

(72) Inventors: Romain MOULIN, LILLE (FR); Renaud HEITZ, VILLENEUVE D'ASCQ (FR); Urbain PRIEUR, LILLE (FR)

(73) Assignee: EXOTEC PRODUCT FRANCE, CROIX (FR)

(21) Appl. No.: 18/992,696

(22) PCT Filed: Jul. 11, 2023
(86) PCT No.: PCT/FR2023/051074

§ 371 Date: Jan. 9, 2025

(30) Foreign Application Priority Data
Jul. 12, 2022 (FR) FR2207156
Oct. 3, 2022 (FR) FR2210086

(51) Int. Cl. B65G 1/06; B65G 1/04; B65G 1/137

(52) U.S. Cl. CPC B65G 1/065; B65G 1/0492; B65G 1/1378

(57) ABSTRACT

A method for order preparation and packing includes bringing at least one storage container for at least one item, by means of at least one vehicle of a first set of self-guiding vehicles adapted to travel across the floor, to an order preparation station; selecting a first cardboard box intended to form the packaging of a parcel for one of the orders; bringing the first cardboard box selected, by means of at least one vehicle of a second set of self-guiding vehicles adapted to travel across the floor, to the order preparation station; and taking at least one item from one of the storage containers and placing the item(s) taken in the first cardboard box selected.

### TECHNICAL FIELD

The present disclosure relates to the field of depot or warehouse logistics, and in particular the automation of the logistics chain.

More specifically, the present disclosure concerns a method for preparing and packing at least one part of an order.

It is particularly applicable to the automation of the management of flows within a storage warehouse and/or depot, for example in a warehouse for the preparation of orders in a logistics chain, to the automation of the sorting of items in a depot or a warehouse, or to the automation of an order delivery service at a pick-up location (“drive”).

### BACKGROUND

In the overall logistics chain, the management of flows and the handling of the products within a warehouse or a depot play a decisive role.

Conventionally, an order picker/packer moves around the warehouse in order to pick each product in an order from its location on a shelf of a shelving unit.

This system means that the picker/packer has to cover long distances during a working day, which is tiring and results in lost time when the route is not optimized.

Another disadvantage is that the picker/packer has to have an extremely good knowledge of the layout of the warehouse so as not to waste time.

To make journeys less tiring, improve the management of picking, and reduce the time taken for order preparation, it has been envisaged to organize warehouses in “Goods to man” mode (according to which the products are brought to the order picker/packers by mechanized means).

It is thus known practice to use conveyors to transport products from a storage zone of a warehouse to an order preparation station and to transport products from the order preparation station to a dispatch station. It is also known practice to use robots to bring the products from this storage zone to an order preparation station, the robots being guided on travel rails set in the floor of the warehouse.

Patent document US2018/0305123A1 describes such a technique, according to which robots are guided to the order preparation station on guide rails, or toothed wheel mechanisms, in an order sequence determined by a centralized order management system. Patent document US2019/0270591 describes a similar technique.

However, this known technique has the disadvantages of being complex and expensive to implement and requires warehouses of large size owing to the space taken up by the travel rails or conveyors alone.

Furthermore, once a storage container is loaded on a conveyor, or a robot is engaged on a travel rail or a ramp for accessing the order preparation station, it is no longer possible to change the order in which they are brought to the order picker/packer, which means that the order sequence in which orders are prepared cannot be changed at short notice. To be specific, the robots or storage containers are necessarily presented to the operator in the order in which they are engaged on the mechanical means that bring them to the order preparation station. There is therefore no scope to change the order in which orders are prepared if there is a change in their order of priority and therefore such an order preparation method is not flexible.

To overcome these disadvantages, the use of mobile robots, in particular AGVs (automated guided vehicles), has been proposed for fetching products from the shelving units and bringing them to an order preparation station. Another idea is to transport products belonging to an order grouped together at an order preparation station to an order dispatch station using robots. These preferably move about robots autonomously, offering greater flexibility in the organization of the order preparation stations. Examples of such mobile robots can be found in particular in patent applications WO 2017/064428, WO 2018/189110 and WO 2022/058569.

Patent document US2021/0221615A1 thus proposes a technique for the preparation of orders according to a rendezvous preparation principle, in which order preparation stations may be designed, on the fly, at any point of the warehouse, depending on requirements and the volume of orders to be prepared.

One disadvantage of this known technique is that the operations of transferring the products from the robots arriving at an order station onto the robots assigned to bring the products belonging to an order to a dispatch station are awkward for an operator: this can result in products being dropped, or collisions, and makes the work of an order picker/packer difficult, to the point where it can even affect their health and, in the long term, lead to musculo-skeletal problems. To be specific, such mobile order preparation stations, while offering the advantage that they can be designed “on the fly”, have the disadvantage of being unergonomic.

In addition to the preparation of the order,

another important step is the packing of said order. In this regard, there are two different types of procedure. The first is known as “pick then pack” and consists in fetching items in the warehouse, then bringing them to the preparation station where they will be sorted into orders and placed together in a collection container, then packaged in a cardboard box. The second, known as “pick and pack”, consists in gathering together all the items belonging to the same order directly in a cardboard box. This latter method is particularly advantageous, as it combines the operations of picking and packing, and thus makes it possible to save a great deal of time in the preparation of the order, by doing away with the step of transferring the items assembled in the collection container into a cardboard box for dispatch of the order.

Thus, for example, techniques are known whereby an order picker/packer takes items brought to an order preparation station by a mobile robot and places them in a cardboard box placed on a conveyor or on a table equipped with racks, where a mobile robot can take hold of this cardboard box from below, notably using forklift based systems in which the prongs slide into the openings in the rack.

A first disadvantage of these known techniques is that the operator has to perform a movement of large amplitude in order to place each item in a cardboard box, which represents a loss of time. Furthermore these operations of transferring the items into a cardboard box are often awkward for an operator, which can result in products being dropped, or collisions, and makes the work of an order picker/packer difficult, to the point where it can even affect their health. Another disadvantage of this known “pick and pack” technique is that, unlike the collection containers used in “pick then pack” techniques, the cardboard boxes for dispatch of the orders may have very varied dimensions, depending on the size and the number of items ordered. It is thus necessary for the operator to adapt to this variety of dimensions of cardboard boxes, meaning that they have to perform a wider range of movements, making their work more difficult and time consuming.

Moreover, in general, management of the fleet of mobile robots within a storage depot or on the shop floor is a complex operation and improvements in efficiency as regards the flexibility of flows, the simplicity of operations, especially packing, and the speed of transfer of the products to make up orders and bring them to a dispatch station, are constantly sought. There is therefore a need for solutions that satisfy these requirements.

### SUMMARY

The present disclosure meets this need by proposing a method for order preparation and packing comprising:
bringing at least one storage container for at least one item, by means of at least one vehicle of a first set of self-guiding vehicles adapted to travel across the floor, to an order preparation station;
selecting a first cardboard box intended to form the packaging of a parcel for one of the orders;
bringing the first cardboard box selected, by means of at least one vehicle of a second set of self-guiding vehicles adapted to travel across the floor, to the order preparation station;
taking at least one item from one of the storage containers and placing the item(s) taken in the first cardboard box selected.

Moreover, the bringing is carried out by moving the vehicles in a travel zone provided on an inclined ramp for accessing the order preparation station; the taking is carried out in a parking zone accessible from said inclined ramp comprising at least two adjacent parking spaces intended to receive respectively a vehicle of the first set and a vehicle of the second set. Furthermore, such a method comprises adjusting a height of at least one of the adjacent parking spaces as a function of dimensions of the first cardboard box and/or of the storage container(s).

According to another aspect, there is proposed a system for order preparation and packing comprising:
at least one order preparation station;
a first set of self-guiding vehicles adapted to travel across the floor and to bring at least one storage container for at least one item to the order preparation station(s);
a second set of self-guiding vehicles adapted to travel across the floor and to bring at least one cardboard box, intended to form packaging of a parcel for one of the orders, to the order preparation station(s).

Moreover, the order preparation station(s) comprise(s):
an inclined ramp for the vehicles to access the order preparation station(s), comprising at least one travel zone for the vehicles,
a parking zone accessible from the inclined ramp comprising at least two adjacent parking spaces intended to receive respectively a vehicle of the first set and a vehicle of the second set,
adjustment means for adjusting a height of at least one of the adjacent parking spaces as a function of dimensions of the cardboard box(es) and/or of the storage container(s).

According to another aspect, there is proposed a computer program product comprising program code instructions for implementing the method as defined herein when this program is executed by a processor.

According to another aspect, there is proposed a non-transitory computer-readable recording medium on which such a program is recorded.

Such a recording medium may be any entity or device capable of storing the program. For example, the medium may include a storage means, such as a ROM, for example a CD ROM or a microelectronic circuit ROM, or a magnetic recording medium, for example a USB key or a hard disk.

Moreover, such a recording medium may be a transmissible medium such as an electric or optical signal, which may be sent via an electric or optical cable, by radio or by other means, such that the computer program it contains is executable remotely. The program according to the invention may in particular be downloaded over a network, for example the Internet.

Alternatively, the recording medium may be an integrated circuit in which the program is incorporated, the circuit being suitable for executing or for being used in the execution of the abovementioned order preparation method.

The features set out in the paragraphs below may, optionally, be implemented independently of one another or in combination with one another:

The parking spaces are at different heights.

The adjacent parking spaces face the position of an operator or of a robotic arm.

At least one of the adjacent parking spaces is inclined relative to the horizontal.

In the event of an error when selecting the first cardboard box, the method comprises:
selecting a second cardboard box intended to form the packaging of the parcel for the order;
moving the vehicle of the second set that brings the first cardboard box, from a first of the adjacent parking spaces to a second of the adjacent parking spaces, freeing up the first parking space;
bringing the second cardboard box selected, by means of at least one vehicle of the second set, to the first parking space that has been freed up;
taking the item(s) placed in the first cardboard box and placing the item(s) taken into the second cardboard box.

The selection of the first and/or the second cardboard box takes into account at least one of the parameters belonging to the group comprising:
a number of items making up the order;
a dimension of items making up the order;
a nature of items making up the order;
a fragility of items making up the order;
a size of an element for wedging and/or protecting items making up the order, to be inserted in the cardboard box;
a dimension of cardboard boxes available.

The selection of a first and/or of a second cardboard box comprises transmission of a piece of information representative of the cardboard box selected to a unit for managing a stock of cardboard boxes.

Such a method further comprises determining an arrangement of the item or items making up the order inside the first and/or second cardboard box as a function of an order sequence in which the storage container(s) for the item or items making up the order are presented in the parking zone.

At least some of the vehicles of the first set of vehicles are also vehicles belonging to the second set of vehicles or vice versa.

Such a method comprises transporting the vehicle that brings the first or second cardboard box selected to a means for closing cardboard boxes at an order dispatch station.

In the event of modification of an order sequence in which are prepared, the method comprises free movement of at least one of the vehicles of the first and/or of the second set of vehicles in at least two perpendicular directions so as to go from the parking zone or from the travel zone to a temporary storage zone for the vehicles, provided on the inclined ramp, and vice versa.

Such a method comprises:
temporarily storing at least one vehicle of the second set in the temporary storage zone until an order associated with a cardboard box brought by the vehicle stored temporarily becomes priority;
moving the vehicle stored temporarily from the temporary storage zone to the travel zone in a first direction of movement and moving the vehicle stored temporarily from the travel zone to the parking zone in a second direction of movement perpendicular to the first direction of movement.

### BRIEF DESCRIPTION OF FIGURES

Further features and advantages of the invention will become more clearly apparent on reading the following description of an embodiment of the invention, provided purely by way of non-limiting illustrative example, and the attached drawings, in which:

FIG. 1 depicts a distribution warehouse of an online business in which an example of an embodiment of an order preparation method according to the invention is implemented;

FIG. 2 is a detailed perspective view of an order preparation and packing station of the warehouse presented with reference to FIG. 1;

FIG. 3 is a partial end-on view of the order preparation and packing station presented with reference to FIG. 2;

FIG. 4 is a partial side view of the order preparation and packing station presented with reference to FIG. 2.

### DETAILED DESCRIPTION

The general principle of the technique forming the subject matter of the present disclosure is based on an order preparation method of “pick and pack” type, according to which items making up an order are collected from a storage area of a warehouse and assembled directly in a cardboard box for dispatch of the order at an order preparation station. In particular, such a method for order preparation and packing is based on the design of an ergonomic order preparation station, to which autonomous robots gain access via an inclined access ramp so as to park in a parking zone comprising several adjacent parking spaces, the height of which is adjustable.

It is thus possible to adjust the position in terms of height of the parking spaces as a function of the dimensions of the storage containers and/or of the cardboard boxes brought by the robots, so as to improve the ergonomics of the order preparation station and facilitate handling by an order picker/packer or by a robotic arm.

An example of an embodiment of such an order preparation method will now be described with reference to the figures.

Throughout this document, the term vehicle, or robot, means any motorized machine equipped with at least two wheels for travelling across a floor (and thus possibly having two, three, four or even more travel wheels) and intended to transport a load, with the exception of flying machines. The terms robots and vehicles are used interchangeably. Examples of such vehicles are for example described in patent documents WO2023001449 and FR3125514 in the name of the applicant.

Preferably, such robots or vehicles are autonomous in their movement, and capable of changing direction very quickly, within a restricted floor area. For example, such robots or vehicles are equipped with a drive wheel mounted on a vertical shaft: when the drive wheel turns about this vertical shaft, it pivots just enough to change the direction of travel, without turning the body of the robot, which may thus change its direction of travel more or less on the spot.

In one embodiment, such robots do not move only in 2D on the floor, but may also move in 3D, by supporting themselves on the shelving units in the warehouse so as to climb up these shelving units in order to search for a storage container or a collection container stored there.

The term “container” designates any device adapted to be transported by a robot and to contain one or more items, objects or products. Below, the term “container” may also designate a bin or a basket, a crate, a chest, a cardboard box, etc.

Note also that, in the present document, the term cardboard box refers to a container, i.e. a box made of cardboard, of generally parallelepiped shape or any other known suitable shape. This box is generally made by folding and/or assembling various sheets of cardboard, for example using adhesive tape. This box may be closed by at least one flap or by a lid, by way of examples. The term cardboard designates a material, namely a material based on paper or a paper-like material, whether this be simple, corrugated, cellular or laminated cardboard, to mention just a few examples.

Furthermore, the terms “items” and “products” may be used interchangeably. They simply refer to an object, in particular a commercial object, stored in a workshop, shop or warehouse, and intended to be delivered to an end customer who has placed an order for it, alone or in combination with one or more other items.

Lastly, the temporary storage zone may be a zone intended for storing orders awaiting delivery at a “drive”, without departing from the context of the present disclosure.

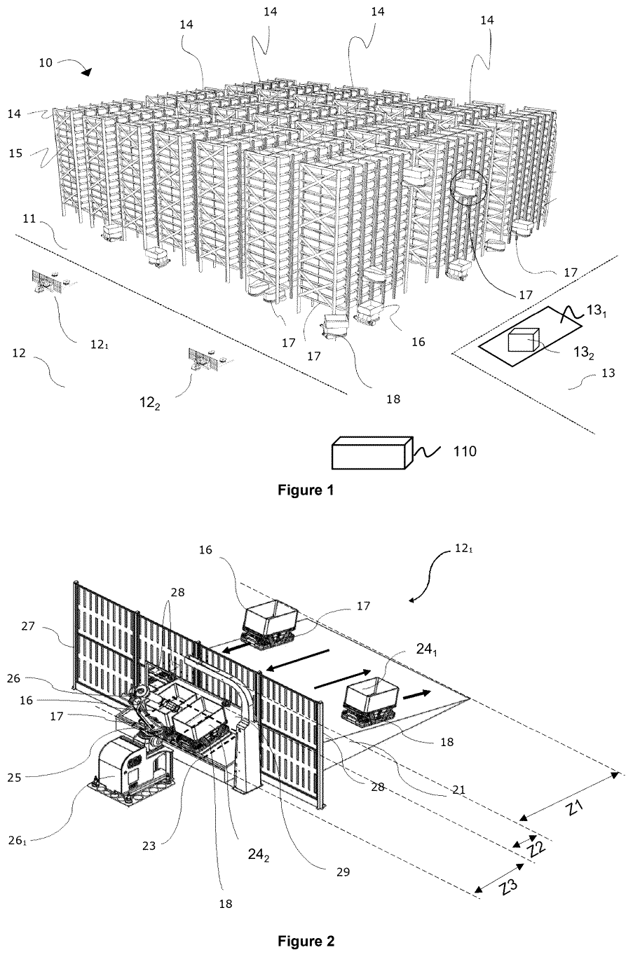

FIG. 1 depicts a robotized distribution warehouse 10 of an online trading company. This warehouse is structured into three areas: a storage area 11, an order preparation and packing area 12 equipped with order preparation and packing stations 12₁ and a dispatch area 13 equipped with a parcel dispatch station 13₁ comprising a means for closing cardboard boxes 13₂.

The storage area 11 is made up of a plurality of shelving units 14 composed of shelves on several levels supported by posts 15, and organized in successive parallel rows. Storage containers 16, which may contain items that are all similar or a plurality of different items belonging to the same range of products, are stored on these shelves. Furthermore, note that some of these shelving units are reserved for the temporary storage of cardboard boxes prefilled with one or more items belonging to the same order, waiting to be transported to a preparation and packing station 12₁ so that the other missing items can be placed in them to finish off the packing of the orders for which they have been assigned or waiting to be brought to the dispatch station 13₁.

A first fleet of self-guiding vehicles 17, equipped for example with four wheels for travelling on the floor, transports the storage containers 16 between the storage area 11 and the order preparation and packing stations 12₁.

When a vehicle 17 receives instructions to go and fetch a bin 16 containing one or more items belonging to an order on a shelving unit, the vehicle 17 travels across the floor as far as the base of the shelving unit 14 where this bin 16 is stored and climbs up along this shelving unit, supporting itself on the shelving unit facing the latter, up to the shelf where this bin 16 is stored, and takes hold of the bin. The vehicle 17 then makes its way back down between the two shelving units, and once back on the floor, transports the bin 16 to an order preparation station 12₁.

This first set 17 thus includes a first set of self-guiding vehicles adapted to travel across the floor, intended to fetch storage containers holding one or more item(s) stored on the shelving units and to transport them to the order preparation station.

A second fleet of self-guiding vehicles 18 transports cardboard boxes selected to form the packaging of the parcels that will contain the orders. These vehicles 18 fetch the selected cardboard boxes from a unit for managing a stock of cardboard boxes 110 which delivers the cardboard boxes, transport the selected cardboard boxes to an order preparation and packing station 12₁ and transport cardboard boxes in which there have already been placed one or more items belonging to the same order and taken from storage bins 16 brought to the order preparation station 12₁ by vehicles 17, from an order preparation station 12₁ to the means for closing cardboard boxes 13₂ of the dispatch station 13₁.

This second set 18 thus includes a second set of self-guiding vehicles adapted to travel across the floor, intended to transport cardboard boxes containing at least some of the items belonging to the same order from an order preparation station 12₁ to a dispatch station 13₁ for dispatching the order, to a temporary storage zone or to a conveyor connected to a dispatch station for dispatching the order.

In this particular embodiment of the invention, the cardboard boxes selected are cardboard boxes known per se, of rectangular parallelepiped shape, open at their top face and equipped with four flaps for closing the opening of the cardboard box. These cardboard boxes may have various dimensions depending on the number and the size of the different items that they are intended to contain.

Provision may be made for a vehicle 17 or 18 to be used both for transporting storage containers 16 to an order preparation and packing station 12₁ and, intermittently, for transporting cardboard boxes to the dispatch station 13₁ or vice versa, as required and depending on the availability of the other vehicles in these fleets at any given time.

This offers great flexibility as regards management of the fleet of vehicles, as the same vehicle may be used either for transporting storage containers or collection containers, and hence may form part of the first or the second set of vehicles as required. Thus, at least some of the vehicles of the first set of vehicles are also vehicles belonging to the second set of vehicles or vice versa, which makes it possible to reduce the total number of vehicles to be used for transporting the storage containers and the collection containers.

The second set of vehicles may be a sub-set of the first set of vehicles or vice versa.

At the start of the preparation of an order or part of an order:
it is assigned a first cardboard box 24₁, an ID of which is recorded in a centralized management system in association with an order number;
a vehicle belonging to the second set 18 fetches this first cardboard box 24₁ from the shelving units;
this vehicle 18 transports the cardboard box 24₁ fetched to an order preparation station 12₁, where it is positioned in a first parking space facing the position of an operator or of a robotic arm.

Likewise, a storage container containing at least one item making up the order or part of the order is assigned to a vehicle belonging to the first set 17, an ID of the vehicle and an ID of the storage container being recorded in association in a centralized management system. The vehicle 17 fetches the storage container assigned to it from the shelving units, and brings it to a second parking space of the order preparation station 12₁, which is adjacent to the first space in which the collection container parked, and which also faces the position of an operator or of a robotic arm.

The operator or the robotic arm may then take one or more items making up the order from the storage container which parked in the second parking space, and place them in the cardboard box which parked in the first parking space adjacent to it.

If all the items making up the order have been placed in the cardboard box 24₁, it may be transported by the vehicle 18 to a dispatch station or on a conveyor for bringing it to this dispatch station, or to a device for closing cardboard boxes for dispatch.

Such an order preparation technique advantageously allows several orders composed of items stored at various different storage locations in the workshop, shop or warehouse to be made up rapidly and at the same time, as will be understood more clearly on reading the description of FIGS. 2 to 4 below.

FIG. 2 shows an order preparation and packing station 12₁ in a detailed profile perspective view.

This order preparation and packing station 12₁ is equipped with a robotic arm 26 known per se, which could also be replaced by a human operator. The base 261 of the robotic arm is fixed or rotates about a shaft that is fixed relative to the floor. In another embodiment, the base of the robotic arm is mounted slidingly on at least one rail. This increases the amplitude of movement of the robotic arm, which may prove to be advantageous in a configuration in which a parking zone of the order preparation station comprises more than two adjacent parking spaces for receiving cardboard boxes or storage containers, as will be seen in more detail below.

The storage containers 16 are brought to this order preparation and packing station 12₁ by vehicles 17 of the first set of self-guiding vehicles which take an inclined access ramp 21, for example on the left hand side. The vehicles 18 of the second set of self-guiding vehicles leave the inclined access ramp 21 via its right hand side, in this particular embodiment of the invention. In this example, the access ramp 21 is a lifting ramp which allows the robots 17, 18, which move about by travelling over the floor of the warehouse from the storage area 11 to the order preparation area 12, to ascend to the order preparation station 12₁. In another example in which the robots travel around on an upper storey of the warehouse, the inclined access ramp 21 could also allow the robot to descend, from this upper storey, to the order preparation station 12₁.

Such robots 17, 18 are autonomous in their movement, and may in particular move in 2D on the inclined ramp 21.

As can be seen in more detail in FIG. 4, which is a side view of the order preparation station 12₁ shown in FIG. 2, the inclined access ramp 21 comprises two distinct zones:
a vehicle travel zone referenced Z1;
a zone referenced Z2 for temporary storage of the vehicles.

The robots 17, 18 may thus travel freely between the travel zone Z1, the temporary storage zone Z2, and a parking zone Z3 which will be described below, depending on the priority level of the order to which they are assigned.

The temporary storage zone Z2 is substantially horizontal and makes it possible to temporarily store at least two vehicles, for example a vehicle of the first set 17 and a vehicle of the second set 18. It may also be dimensioned to allow the simultaneous storage of a greater number of vehicles, as required.

The existence of a temporary storage zone Z2 at the order preparation station advantageously allows temporary storage of some of the items of an order being prepared, for example while awaiting replenishment of an item ordered but not in stock at the warehouse or the depot, or when it is necessary to delay the dispatch of the order.

This zone Z2 may comprise means for charging a battery of the vehicles 17, 18, while they are temporarily stopped in the zone Z2. This may consist of, for example, inductive charging modules, also called pads, which make it possible to charge the batteries of the vehicles while they are parked on the ramp. This saves time and space, since it is not necessary to provide extra charging stations or at the very least makes it possible to reduce the capacity and/or the number of the other charging stations. These charging means may also be positioned in the travel zone Z1. For example, charging pads 28 are provided on each of the edges of the ramp 21 for charging the batteries of the robots 17 or 18.

The vehicle travel zone Z1 comprises at least two arrival paths and at least two departure paths for the vehicles, symbolized by arrows in FIG. 2, to allow very fluid movement of the vehicles 17, 18, and hence simultaneous management of the preparation of several orders. For example, the inclined ramp 21 has a width greater than or equal to the width of four vehicles, preferably greater than or equal to the width of six vehicles to allow vehicles 17, 18 to move up and down simultaneously on the access ramp 21 with several vehicles passing one another. Thus, a vehicle 17 transporting a first storage container and a vehicle 18 transporting a first cardboard box may go up the access ramp 21 at the same time to access the order preparation station, where the preparation of the order to which they are assigned begins, while a vehicle 17 transporting a second storage container and a vehicle 18 transporting a second cardboard box are going down at the same time, as the preparation of the order to which they are assigned is complete.

The order preparation station further comprises a parking zone referenced Z3, which the vehicles 17, 18 access from the inclined ramp 21. The upper end of the ramp 21 is topped by a grating 27 separating the parking zone Z3 from the travel zone Z1 and temporary storage zone Z2 for the vehicles 17 and 18. An opening 29 is moreover formed in this grating to allow the vehicles 17 and 18 to access the parking spaces in this parking zone Z3, within the reach of the robotic arm 26. In the example of an embodiment shown in FIGS. 2 to 4, a parking zone Z3 comprising exactly two parking spaces is depicted, and the opening 29 is therefore dimensioned to allow the simultaneous passage of two vehicles. The parking zone may however comprise a greater number of parking spaces, for example four or six, according to the width of the ramp 21. In this case, the opening 29 in the grating 27 is of course adapted to allow the simultaneous passage of four or six vehicles, as a function of the number of parking spaces.

The presence, in the parking zone Z3, of more than two adjacent spaces 23, 25 advantageously makes it possible to reduce the time taken for preparation of the orders. It is thus possible to position, in the parking containers transporting zone Z3, several storage different items required for an order (for example, a container of ping-pong balls and a container of ping-pong bats). The ping-pong balls are taken from the first container and placed in the cardboard box 24₁, then the ping-pong bats are immediately taken from the second container, without it being necessary to wait for the container of bats to take the place of the container of balls in the parking for storage space reserved containers. It is also possible to have several cardboard boxes 24 in the parking zone, which is advantageous when the same item is required for the preparation of several orders. For example, if three customers have ordered ping-pong balls, three cardboard boxes 24 may be placed in the parking zone Z3, with the storage container containing the ping-pong balls. It is then possible to take ping-pong balls from the storage container 16 and place them successively and rapidly in each of the three cardboard boxes 24.

The adjacent spaces of the parking zone Z3 preferably face the operator or the robotic arm 26, and are within their reach, to enhance the ergonomics of the order preparation station 12₁. Thus, the operator does not have to walk around or move the motorized arm on the floor to transfer the items of an order between the storage containers 16 and the cardboard boxes 24. This transfer is achieved with a simple and ergonomic movement of an arm of the operator or of the robotic arm 26 and in a short time.

Moreover, these adjacent spaces, which are accessible from the inclined ramp 21 providing access to the order preparation station, are preferably placed at person height, so that the operator does not have to bend down to handle the items making up the order. This reduces the amplitudes of movements required of the operator, and therefore the risk of developing musculo-skeletal problems.

To further improve the ergonomics of the order preparation station, provision may be made for the respective parking spaces 23 and 25 of the robots 18 and 17 to be height-adjustable, or to be at different heights, so as to adapt to the dimensions of the storage containers and of the cardboard boxes. It is thus possible to independently adjust the height of the top opening of the storage containers and of the top opening of the cardboard boxes, for example so as to position these openings substantially at the same level if the storage containers and the cardboard boxes have different height dimensions. This is particularly advantageous for the parking space intended to receive the cardboard box for dispatching the order, as clearly the dimensions may vary from one order to another, depending on the number of items ordered by the customer, or their size. In the case where several orders are prepared in parallel, and where several dispatch cardboard boxes are thus parked in adjacent spaces of the parking zone, it is thus possible to individually adjust the height of the parking space for each of the collection cardboard boxes, according to their dimensions, which have been selected as a function of the volume of items ordered.

Thus, if the height of the cardboard box 24 is smaller than the height of the storage container 16, the parking space receiving the cardboard box 24 is higher than the parking space receiving the storage container 16, so that the top opening of the cardboard box 24 is at the same height as the top opening of the storage container 16.

By allowing the height of the parking space for the collection cardboard box to be adjusted to the height of the latter, it is ensured that its top opening is always positioned at the right level for the operator or the robotic arm, thereby enhancing the ergonomics of the order preparation station. Such a height adjustment may be performed by means of an adjustment toothed rack or using motorized lift means, which may be controlled by the centralized management system, as a function of the dimensions of the collection cardboard box selected from the shelving units. These dimensions are known to the centralized management system, from the ID of the collection cardboard box associated with the ID of the order under preparation.

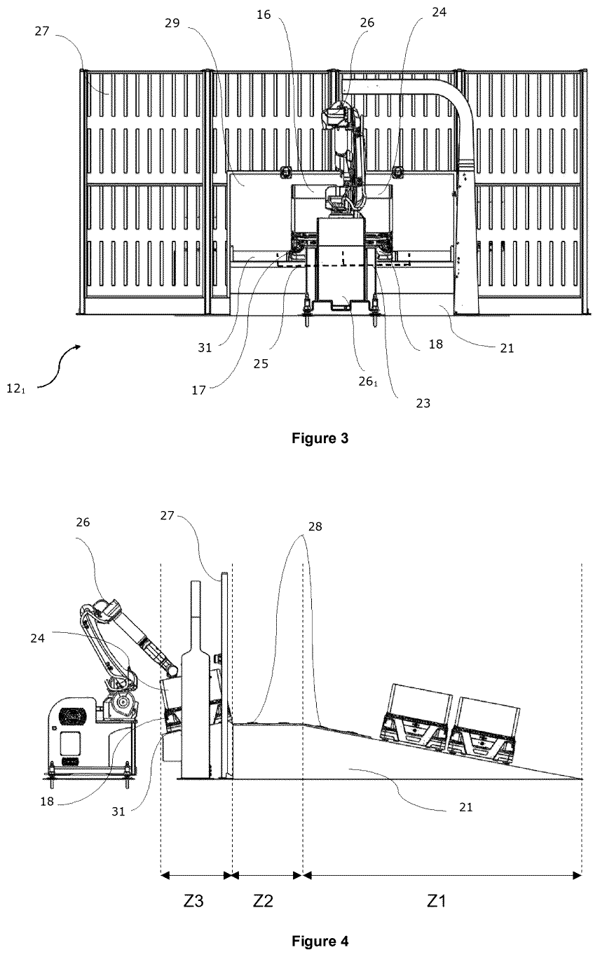

The robotic arm 26, mounted on a fixed base 26₁, is intended to take an item from a storage container 16, brought by a vehicle 17, in a predetermined parking space 25 at the end of the ramp 21 (depicted in dotted lines in FIG. 2 and in FIG. 3, which is an end-on view of the order preparation and packing station 12₁) and to place it in a cardboard box 241, transported by a vehicle 18, in a predetermined parking space 23 at the end of the ramp 21 (depicted in dotted lines in FIGS. 2 and 3).

This cardboard box 24₁ selected to form the packaging of the order being prepared has been fetched by the vehicle 18 from the unit for managing a stock of cardboard boxes 110. The selection of the format of this cardboard box within a set of available formats of cardboard boxes stored in the unit for managing a stock of cardboard boxes 110 has been made by a dedicated software application on the basis of the number of items making up the order, their dimensions, their nature, their shape, or their fragility, and on the basis of how these items need to be wedged to ensure that they are suitably protected. Such a software application may receive all of this information as input parameters, this information being for example memorized in a database of the centralized management system of the warehouse in association with the references of the items ordered. A packaging optimization algorithm calculates, from all of these input parameters, the optimal dimensions of the cardboard box 24₁ to be selected, out of the stock of cardboard boxes of the stock management unit 110. When a vehicle 18 selects the optimal cardboard box 24₁, a piece of information representative of the cardboard box selected is transmitted to the unit for management of the stock of cardboard boxes, so that it deducts one unit from the stock of cardboard boxes managed. An ID of the cardboard box 24₁ may also be memorized in the central management system in association with an ID of the order.

Such a software application may also determine an optimal arrangement of the items making up the order in the cardboard box 24₁ selected, as a function of their respective shape and fragility, for example, or of the available wedging and protection elements, and control the order of presentation of the storage containers of items in the parking zone Z3 as a function of the optimal arrangement determined.

In another embodiment, such an application may also determine an optimal arrangement of the items making up the order in the cardboard box 24₁ selected as a function of the order of presentation of the storage containers of items making up the order in the parking zone Z3, as determined by the central management system for managing the fleet of robots 17, 18.

In another embodiment, the selection of the cardboard box 24₁ is performed by an operator with complete autonomy, or with the assistance of a dedicated software application.

Since the first parking space 25 and the second parking space 23 for the vehicles are advantageously adjacent and face the robotic arm 26, the movements of the arm 26, for each item handled, are limited to taking an item from the storage bin 16, rotating the arm so as to position the arm above the cardboard box 24, placing, via a substantially vertical movement, the item in the cardboard box 24 and returning to its initial position, which makes it possible to repeat these operations at a high rate. The same goes for a configuration with three, four or six adjacent parking spaces, only the amplitude of movement of the arm then being increased.

As will thus be easily understood, in variants of this particular embodiment of the invention, in which the operations carried out by the robotic arm are performed by an operator, in addition to the saving on time afforded by this arrangement, the risk of developing musculo-skeletal problems is drastically reduced for the operator, as is the risk of items falling onto the floor if they slip out of the hand of the operator.

The first parking space 25 and the second parking space 23 are formed of two substantially adjacent flat surfaces which constitute the parking zone Z3 forming a portion extending the upper part of the ramp 21. In a configuration with four or six parking spaces, the zone Z3 takes the form of an inclined flat surface which extends the upper part of the ramp, and the width of which corresponds substantially to the width of four or six vehicles, depending on the number of parking spaces.

The items to be taken may thus be easily placed at the height of an operator, which also makes it easier to place them in the cardboard boxes 24.

As can also be seen in FIG. 4, the parking zone referenced Z3 is inclined relative to the horizontal. When the inclined access ramp 21 is a lifting ramp, this parking zone Z3 has in particular an angle of inclination relative to the horizontal of opposite sign to that of the access ramp 21. Thus, the respective parking spaces 23 and 25 for the vehicles 18 and 17 are in a plane inclined 31 relative to the horizontal at the upper end of the ramp 21, which facilitates access by the robotic arm to the items in the storage containers 16 and makes it easier to place them in the cardboard boxes 24.

The design of such an access ramp 21 has the technical effect of providing a highly ergonomic order preparation station, and also allows great flexibility in the management of cardboard boxes 24 of different dimensions, as well as great flexibility for adaptation in the event of an error in the selection of the cardboard box appropriate for an order. This makes it possible to substantially reduce the time taken for preparation of the orders, and to optimize the efficiency of processing of multiple orders.

To be specific, as can be seen in FIGS. 2 to 4, it is possible to start the preparation of an order at the order preparation station 12₁, with the aid of a first cardboard box 24₁ brought by a vehicle 18 of the second set, by asking an operator or a robotic arm 26 to place therein some of the items making up the order, these items being contained in various storage containers that have been transported beforehand to the order preparation station 12₁, by a plurality of vehicles of the first set 17 of vehicles.

In the case where the dimensions of the first cardboard box 24₁ are ultimately not suitable for the volume of the items making up the order (for example because the customer has added an extra item to their order after the first cardboard box 24₁ has been selected, or in the event of an initial error in the selection of the format of cardboard box by the operator), a second cardboard box 24₂ of more appropriate dimensions is selected and brought by a vehicle of the second set 18 to a parking space in the parking zone Z3. The first and the second cardboard boxes are preferably placed in adjacent parking spaces.

For example, in an embodiment in which the parking zone Z3 includes two adjacent parking spaces, the vehicle of the second set 18 bringing the first cardboard box 24₁ moves from the first parking space 25 to the second parking space 23, and thus frees up the first parking space 25. A vehicle of the second set 18 then brings the second cardboard box 24₂ to the first parking space 25 which has been freed up. The operator or the robotic arm 26 may then take the items which were placed in the first cardboard box 24₁ so as to place them in the second cardboard box 24₂. When all of the items have been taken out of the first cardboard box 24₁, the vehicle 18 which transports it may give up its spot in the parking space 23 for a vehicle 17 transporting a storage container 16 containing the items missing from the order. The missing items are in turn taken from the storage container 16 and placed in the second cardboard box 24₂. When all of the items making up the order have been placed in the second cardboard box 24₂, the latter may be brought to a device for closing cardboard boxes at an order dispatch station, before dispatch to the end customer.

Such a method thus makes it possible to correct an error concerning the size of the cardboard box selected by an operator or a software application. To be specific, if, as the items of an order are being placed successively in a selected cardboard box, the operator or the software application notices, for example when trying to place a new item in the cardboard box, that the cardboard box initially selected is actually too small to hold all of the items for which this cardboard box has been provided, the operator or the application may select another, larger cardboard box which will be fetched by another vehicle of the second set and transported to the second space, while the vehicle of the second set carrying the cardboard box initially selected will receive instructions to leave the second space in order to free up the space for the vehicle carrying the newly selected cardboard box, and move over to the first space.

The operator or the robotic arm may then take the items out of the cardboard box initially selected and place them in the newly selected cardboard box.

Moreover, it is also possible to start a first order at the order preparation station 12₁, with the aid of a first cardboard box 24₁ brought by a vehicle 18 of the second set, by asking an operator or a robotic arm 26 to place therein some of the items making up the first order, these items being contained in various storage containers that have been transported beforehand to the order preparation station 12₁, by a plurality of vehicles of the first set 17 of vehicles.

In the case where the preparation of a second order becomes priority or if it is not possible to complete the preparation of the first order because one of the items in the order is missing, the vehicle of the second set 18 gives up its spot in the first parking space 23 to another vehicle of the second set 18 carrying a second cardboard box 24 for the preparation of a second order and transports the first cardboard box 24 in which some of the items of the first order have been placed into the temporary storage zone Z2, to await completion of the first order.

If the first and the second cardboard box are not the same height, it is possible to adjust the height of the parking space in which the vehicle 18 carrying the cardboard box of the second order is positioned, so as to position the second cardboard box as ergonomically as possible. This adjustment may be carried out automatically, for example by scanning a bar code or a QR code located on the second cardboard box, using a scanning device arranged in or close to the parking zone Z3. Such a code contains for example information on the height of the cardboard box. A motorized system for adjusting the height of the parking space sets the optimal position of the cardboard box facing the operator or the robotic arm, as a function of the height of the cardboard box deduced from scanning the bar code or the QR code.

The preparation of the second order may then start, with a request to the operator or to the robotic arm to place items of the second order, contained in storage containers brought to the order preparation station 12₁ by vehicles of the first set 17, into the second cardboard box 24. Once some or all of the items of the second order have been placed in the second cardboard box, the latter may be sent to the temporary storage zone Z2 (if preparation of this second order is not complete, for example because an item is missing), to a dispatch station (if preparation of this second order is complete) or to a conveyor linked to a dispatch station.

To sum up, it is possible to envisage at least three modes of operation for preparing an order by virtue of the system of FIGS. 2 to 4:

### Example 1: Preparation of a “Simple” Order Made up of a Single Item

After having assigned a vehicle of the first set 17 to the storage container containing the single item of the order, this vehicle transports the storage container to the order preparation station 12₁: it travels, via the travel zone Z1 of the access ramp 21, up to the parking zone Z3, where it parks in the second predetermined parking space 25. The operator or a robotic arm 26 takes the item and places it in a cardboard box 24 located in the first predetermined parking space 23. This collection container has been transported by a vehicle of the second set 18 of vehicles, through the travel zone Z1, up to the parking zone Z3. The collection container may then be transferred to a temporary storage area (for example, to await “drive” pick-up of the order by the end customer) or to a dispatch station.

If several “simple” orders, for several customers, are made up of the same item, it is also possible to position several cardboard boxes 24 in several adjacent spaces in the parking zone Z3, with the storage container containing the single item ordered. In this case, the height of the parking space of each of these cardboard boxes is preferably adjusted as a function of their respective height. The operator or the robotic arm takes the item and places it successively in each of the cardboard boxes, the respective top openings of which have all been adjusted to the same level. These cardboard boxes may then be transferred to a temporary storage area or to a dispatch station.

### Example 2: Preparation of a “Simple” Order Made up of Several Different Items Stored at Different Locations in a Warehouse

The preparation of the order proceeds in a manner substantially similar to Example 1. Since the order comprises several items, in this case several vehicles of the first set 17 are provided to go and fetch the storage containers which each contain one of the items making up the order, after assigning to each of them one of the storage containers to be fetched, and to present them one after the other at the second predetermined parking space 25. An operator or a robotic arm 26 then successively takes out the various items making up the order and places them in a cardboard box located in the first predetermined parking space 23, brought by a vehicle of the second set 18 of vehicles.

Thus, if the parking zone includes two parking spaces 23 and 25, a first vehicle 17 bringing a first storage container with a first item of the order goes up the access ramp 21 via the travel zone Z1 and accesses the parking zone Z3. The first item is taken out by the robotic arm 26 and placed in the cardboard box located in the space 23 directly adjacent to the parking space 25 of this first vehicle 17. This first vehicle may then go straight back down the inclined ramp 21, via the same path of the travel zone Z1 that it came up, or via another downward path of this travel zone Z1. The vehicle may easily go from one path to the other by executing a movement in a direction perpendicular to the direction of these travel paths, for example by its drive wheel rotating on the spot. While this first vehicle is going down the ramp 21, a second vehicle 17 bringing a second storage container with a second item of the order goes up the access ramp 21 via a free travel path of the access ramp 21. The two vehicles may go up and down simultaneously, which affords a substantial time saving for the preparation of the order. When it arrives at the top of the ramp 21, if the upward path that it took is not opposite the parking zone, the second vehicle 17 may move in a direction perpendicular to the direction in which it came up, until it is opposite its parking space. It then pivots again by 90° so as to move forwards as far as its parking space, in a direction parallel to the direction in which it came up the ramp 21.

Once again, the robotic arm 26 takes the second item making up the order from the storage container parked in the parking space 25 and places it in the cardboard box parked in the adjacent parking space 23. The second vehicle 17 may then leave the parking zone Z3, and go back, via the travel zone Z1, to the storage area 11 where it will put the storage container back on the shelving units 14. It may also leave the parking zone Z3 and head for another order preparation station at which the items it contains are required for the preparation of another order. Lastly, it may leave the parking zone Z3 and park temporarily in the temporary storage zone Z2, in the case where the items it contains may be used for the preparation of another order to be made up shortly at this same order preparation station 12₁. To be specific, in this case, it is advantageous for the vehicle to remain at the order preparation station, to avoid any unnecessary movements and therefore reduce the time taken for processing of the order. It is thus advantageous for the temporary storage zone Z2 to be able to store several vehicles, if all of them may be used for the preparation of a future order.

When the preparation of an order is complete, because all of the items making up the order have been collected, the cardboard box which is assigned to it may be transferred to a temporary storage area or to a dispatch station, where it may be closed before being dispatched.

If, on the other hand, the parking zone Z3 includes more than two parking spaces, it is possible for a cardboard box transported by a vehicle 18 and various storage containers transported by vehicles 17 of the first set and each containing an item making up the order to park simultaneously in this zone. This further speeds up the time taken for processing of the order, since the various items may be taken out successively and rapidly by the robotic arm from each of the storage containers and placed in the cardboard box. For enhanced ergonomics, the height of the parking space of each storage container or cardboard box is adjusted as a function of the dimensions of the latter. This adjustment may be automated or performed manually by the operator. As soon as an item has been taken from a storage container by the operator or the robotic arm, the vehicle on which it is transported may leave the ramp and give up its spot to another vehicle.

### Example 3: Preparation of Part of an Order Comprising Several Items and Placing This Order on Standby so as to Prepare Another Order Which has Become Priority in the Meantime

In this example, preparation of an order C1 starts in the same way as in Example 2. If another order C2 becomes priority, the transfer of the items making up the order C1 being prepared, into the cardboard box in the parking zone Z3 is interrupted, and this cardboard box is transported on the vehicle of the second set 18 which carries it to the temporary storage zone Z2. This frees up the first predetermined parking space 23 for a vehicle of the second set 18 carrying the cardboard box assigned to the order C2 which has become priority and the preparation of the order C2 which has become priority may start by transporting storage containers containing items making up the order C2 with the aid of vehicles of the first set 17 of vehicles, to the second parking space 25. Preferably, before preparation of the order C2 commences, the height of the parking space of the cardboard box assigned to it is first adjusted, in particular if the latter does not have the same format as the cardboard box assigned to the first order C1.

Thus, the vehicle 18 assigned to the order C1 parks temporarily in the temporary storage zone Z2. During this time, the vehicles 17 bringing the storage containers with the items making up the order C2 travel via the travel zone Z1 so as to successively access the parking zone Z3. When the robotic arm 26 has taken an item for the order C2 from one of these vehicles 17, the latter may leave the ramp 21 via the travel zone Z1, while the next vehicle 17 comes up, in parallel, via another path for accessing the ramp. When the preparation of the order C2 is complete, the vehicle 18 assigned to the order C1 leaves the temporary storage zone Z2 and goes back to the parking zone Z3, where preparation of the order C1 may recommence. The vehicles may go from one access path to the other, or from the travel zone to the temporary storage zone, or from the temporary storage zone to the parking zone, by moving in at least two perpendicular directions, namely a direction parallel to the access paths and a direction perpendicular to the access paths.

The examples of modes of operation above are in no way limiting on the way in which the vehicles, the items and the orders are managed when implementing the method of t the present disclosure. They are simply intended to illustrate the flexibility offered by the method as regards the management of the vehicles and of the stock of cardboard boxes and as regards the make-up of the orders.

To be specific, the structuring of the order preparation station into three zones, the possible height adjustment of the adjacent parking spaces for the vehicles, the configuration of the inclined access ramp which has several paths for the vehicles to go up and down, combined with the great mobility of the vehicles, allow a high degree of flexibility in managing the order sequence in which the orders are prepared, placing them on standby and restarting them as required, as a function of changes in their level of priority and in the dimensions of the cardboard boxes for their dispatch.

In order to limit losses of time when bringing the various storage containers for making up an order to a parking space 25, the vehicles 17 are advantageously positioned in a line one behind the other on the ramp 21 waiting until a place in one of the parking spaces 25 is freed up by the preceding vehicle, after the item or items making up the order have been taken from the storage container supported by this vehicle by the robotic arm 26, by moving off to the side so as to go back down the ramp via a downward path parallel to the upward path.

### Patent Documents

The following patent documents are cited for all due purposes:
patcit1: US2018/0305123A1 (publication number);
patcit2: US2019/0270591 (publication number);
patcit3: US2021/0221615A1 (publication number);
patcit4: WO2023001449A1 (publication number);
patcit5: FR3125514A1 (publication number);
patcit6: WO2017064428A1 (publication number);
patcit7: WO2018189110A1 (publication number);
patcit8: WO2022058569A1 (publication number).

1-15. (canceled)

16. A method for order preparation and packing comprising:
bringing at least one storage container for at least one item, by means of at least one vehicle of a first set of self-guiding vehicles adapted to travel across the floor, to an order preparation station;
selecting a first cardboard box intended to form the packaging of a parcel for one of said orders;
bringing said first cardboard box selected, by means of at least one vehicle of a second set of self-guiding vehicles adapted to travel across the floor, to said order preparation station;
taking at least one item from one of said storage containers and placing said at least one item taken in said first cardboard box selected;
said bringing is carried out by moving said vehicles in a travel zone provided on an inclined ramp for accessing said order preparation station,
said taking is carried out in a parking zone accessible from said inclined ramp comprising at least two adjacent parking spaces intended to receive respectively a vehicle of said first set and a vehicle of said second set,
and in that it comprises adjusting a height of at least one of said adjacent parking spaces as a function of dimensions of said first cardboard box and/or of said at least one storage container.

17. The method for order preparation and packing according to claim 16, wherein said at least two parking spaces are at different heights.

18. The method for order preparation and packing according to claim 16, wherein said at least two adjacent parking spaces face the position of an operator or of a robotic arm.

19. The method for order preparation and packing according to claim 16, wherein at least one of said adjacent parking spaces is inclined relative to the horizontal.

20. The method for order preparation and packing according to claim 16, wherein, in the event of an error when selecting said first cardboard box, said method comprises:
selecting a second cardboard box intended to form the packaging of the parcel for said order;
moving said vehicle of the second set that brings said first cardboard box from a first of said adjacent parking spaces to a second of said adjacent parking spaces, freeing up said first parking space;
bringing said second cardboard box selected, by means of at least one vehicle of said second set, to said first parking space that has been freed up;
taking said at least one item placed in said first cardboard box and placing said at least one item taken into said second cardboard box.

21. The method for order preparation and packing according to claim 16, wherein said selection of the first and/or the second cardboard box takes into account at least one of the parameters belonging to the group comprising:
a number of items making up the order;
a dimension of items making up the order;
a nature of items making up the order;
a fragility of items making up the order;
a size of an element for wedging and/or protecting items making up the order, to be inserted in the cardboard box;
a dimension of cardboard boxes available.

22. The method for order preparation and packing according to claim 16, wherein said selection of a first and/or of a second cardboard box comprises transmission of a piece of information representative of said cardboard box selected to a unit for managing a stock of cardboard boxes.

23. The method for order preparation and packing according to claim 16, further comprising: determining an arrangement of said item or items making up said order inside said first and/or second cardboard box as a function of an order sequence in which said at least one storage container for said item or items making up said order are presented in said parking zone.

24. The method for order preparation and packing according to claim 16, wherein at least some of the vehicles of said first set of vehicles are also vehicles belonging to said second set of vehicles or vice versa.

25. The method for order preparation and packing according to claim 16, further comprising: transporting said vehicle that brings said first or second cardboard box selected to a means for closing cardboard boxes at an order dispatch station.

26. The method for order preparation and packing according to claim 16, wherein, in the event of modification of an order sequence in which orders are prepared, said method comprises free movement of at least one of said vehicles of the first and/or of the second set of vehicles in at least two perpendicular directions so as to go from said parking zone or from said travel zone to a temporary storage zone for said vehicles, provided on said inclined ramp, and vice versa.

27. The method for order preparation according to claim 26, further comprising:
temporarily storing at least one vehicle of said second set in said temporary storage zone until an order associated with a cardboard box brought by said vehicle stored temporarily becomes priority;
moving said vehicle stored temporarily from said temporary storage zone to said travel zone in a first direction of movement and moving said vehicle stored temporarily from said travel zone to said parking zone in a second direction of movement perpendicular to said first direction of movement.

28. A computer program product comprising program code instructions for implementing the method according to claim 16 when this program is executed by a processor.

29. A non-transitory computer-readable recording medium on which is recorded a program for implementing the method according to claim 16 when this program is executed by a processor.

30. A system for order preparation and packing comprising:
at least one order preparation station;
a first set of self-guiding vehicles adapted to travel across the floor and to bring at least one storage container for at least one item to said at least one order preparation station;
a second set of self-guiding vehicles adapted to travel across the floor and to bring at least one cardboard box intended to form packaging of a parcel for one of said orders, to said at least one order preparation station;
said at least one order preparation station comprises:
an inclined ramp for said vehicles to access said at least one order preparation station, comprising at least one travel zone for said vehicles,
a parking zone accessible from said inclined ramp comprising at least two adjacent parking spaces intended to receive respectively a vehicle of said first set and a vehicle of said second set,
adjustment means for adjusting a height of at least one of said adjacent parking spaces as a function of dimensions of said at least one cardboard box and/or of said at least one storage container.
